(19) United States
(12) Patent Application Publication
(10) Pub. No.: US 2023/0028117 A1
(43) Pub. Date: Jan. 26, 2023

(54) BATTERY WIRING MODULE

(71) Applicant: SUMITOMO WIRING SYSTEMS, LTD., Mie (JP)

(72) Inventors: Kenta SAWAI, Mie (JP); Hisayoshi YAITA, Mie (JP); Ryota MORI, Mie (JP); Hiroki SAKURAI, Mie (JP)

(21) Appl. No.: 17/787,030

(22) PCT Filed: Dec. 14, 2020
(86) PCT No.: PCT/JP2020/046575

§ 371 Date: Jun. 17, 2022

(30) Foreign Application Priority Data
Dec. 26, 2019 (JP) 2019-236077

(51) Int. Cl. H01M 50/298; H01M 50/507

(52) U.S. Cl. CPC H01M 50/298; H01M 50/507

(57) ABSTRACT

The present disclosure provides a battery wiring module capable of reducing interference with module-side terminals at the time when bus bars are attached. The battery wiring module includes: a module-side terminal electrically connected to a bus bar B that connects battery terminals of a plurality of battery cells to each other; and an electric wire to which the module-side terminal is connected on one end side; and a housing that accommodates the electric wire and the module-side terminal. A housing body 21 constituting the housing includes an interference reduction portion 33 interposed between the bus bar B and the module-side terminal 13.

### TECHNICAL FIELD

The present disclosure relates to a battery wiring module.

### BACKGROUND

As disclosed in Patent Document 1, for example, in vehicles such as electric vehicles and hybrid vehicles, a high-voltage secondary battery, which is installed as a power supply for traveling and driving, is provided with a battery wiring module. In the battery wiring module, module-side terminals are connected to bus bars that connect a plurality of battery cells constituting the secondary battery to each other.

### PRIOR ART DOCUMENT

### Patent Document

Patent Document 1: JP 2015-002164 A

### SUMMARY OF THE INVENTION

### Problems to be Solved

In the battery wiring module as described above, for example, when the bus bar is electrically connected to the module-side terminal by post-attachment, there is a possibility that the bus bar will interfere with the pre-attached module-side terminal and apply a load to the module-side terminal.

An object of the present disclosure is to provide a battery wiring module capable of reducing interference with a module-side terminal at the time when a bus bar is attached.

### Means to Solve the Problem

A battery wiring module in the present disclosure includes: module-side terminals electrically connected to bus bars that connect battery terminals of a plurality of battery cells to each other; electric wires connected to the module-side terminals; and a housing that houses the electric wires and the module-side terminals, wherein the housing includes interference reduction portions interposed between the bus bars and the module-side terminals.

### Effect of the Invention

According to the battery wiring module of the present disclosure, it is possible to reduce interference with the module-side terminal at the time when the bus bar is attached.

### BRIEF DESCRIPTION OF THE DRAWINGS

FIG. 1 is a perspective view of a battery wiring module according to an embodiment.

FIG. 2 is an enlarged plan view showing a part of the battery wiring module according to the embodiment.

FIG. 3 is a plan view showing a state in which an electric wire and a module-side terminal of the battery wiring module according to the embodiment are omitted.

FIG. 4 is an enlarged perspective view showing a part of the battery wiring module according to the embodiment.

FIG. 5 is an enlarged perspective view showing a part of the battery wiring module according to the embodiment.

FIG. 6 is an enlarged plan view showing a part of the battery wiring module according to the embodiment.

FIG. 7 is a plan view showing a state in which the electric wire and the module-side terminal of the battery wiring module according to the embodiment are omitted.

FIG. 8 is an enlarged perspective view showing a part of the battery wiring module according to the embodiment.

FIG. 9 is an enlarged perspective view of a part of the battery wiring module according to the embodiment.

### DETAILED DESCRIPTION TO EXECUTE THE INVENTION

### Description of Embodiments of the Present Disclosure

First, embodiments of the present disclosure will be listed and described.

1. A battery wiring module in the present disclosure includes module-side terminals electrically connected to bus bars that connect battery terminals of a plurality of battery cells to each other; electric wires connected to the module-side terminals; and a housing that houses the electric wires and the module-side terminals, wherein the housing includes interference reduction portions interposed between the bus bars and the module-side terminals.

According to this configuration, because the movement of the bus bars in a connection direction of the bus bars and the module-side terminals is regulated by the interference reduction portions, it is possible to reduce interference of the bus bars with the module-side terminals.

2. It is preferable that a plurality of the interference reduction portions are provided for each bus bar.

According to this configuration, because the plurality of the interference reduction portions are provided for each bus bar, it is possible to more reliably reduce interference of the bus bars with the module-side terminals.

3. It is preferable that a plurality of types of the interference reduction portions are provided for each bus bar.

According to this configuration, because the plurality of types of the interference reduction portions are provided for each bus bar, it is possible to more reliably reduce interference of the bus bars with the module-side terminals.

4. It is preferable that the housing includes a pair of wall portions provided apart from each other at a position where the bus bars are interposable, and the interference reduction portions each include a first interference reduction portion provided to straddle the pair of wall portions and a second interference reduction portion interposed between the bus bar corresponding to the interference reduction portion and the corresponding module-side terminal at a position apart from the first interference reduction portion.

According to this configuration, the movement of the bus bars can be regulated due to the first interference reduction portions provided to straddle the pair of wall portions, and rotation of the bus bars can be regulated due to the second interference reduction portions interposed between the bus bars and the module-side terminals at positions apart from the first interference reduction portions.

5. It is preferable that the second interference reduction portions are provided to extend from one of the pair of wall portions toward the module-side terminals.

According to this configuration, because the second interference reduction portions are provided to extend from one of the pair of wall portions toward the module-side terminals, it is possible to dispose the second interference reduction portions in the vicinity of the module-side terminals. With this configuration, it is possible to more reliably reduce interference with the module-side terminals.

6. It is preferable that the housing includes bus bar holding portions that hold the bus bars.

With this configuration, the bus bars can be held by the bus bar holding portions.

7. It is preferable that the bus bar holding portions are located on an opposite side to the interference reduction portions in a connection direction of the module-side terminals and the bus bars with respect to the module-side terminals.

According to this configuration, the bus bar holding portions are located on one side of the module-side terminals, and the interference reduction portions are provided on the other side of the module-side terminals. That is to say, even in a case where the module-side terminals are pushed by the bus bars when attaching the bus bars held by the bus bar holding portions, the movement of the bus bars is regulated by the interference reduction portions. With this configuration, it is possible to more reliably reduce interference with the module-side terminals.

8. It is preferable that the bus bar holding portion each include only one set of an elastically deformable elastic support piece and a fixing support piece that is paired with the elastic support piece.

With this configuration, the bus bars can be easily attached by the elastic support pieces elastically deforming when the bus bars are attached, and the bus bars can be held by the elastic support pieces and the fixing support pieces by the elastic support pieces returning to their original positions after the bus bars are attached.

### DETAILS OF EMBODIMENTS OF THE PRESENT DISCLOSURE

Specific examples of the battery wiring module in the present disclosure will be described below with reference to the drawings. In the drawings, for convenience of description, a part of the configuration may be exaggerated or simplified. Also, the dimensional proportions of the parts may be different in the drawings. In the present specification, “parallel” and “orthogonal” include not only strictly parallel and orthogonal, but also substantially parallel and orthogonal, within a range in which the operation and effect of the present embodiment are exhibited. Note that the present disclosure is not limited to these illustrative examples, but is indicated by the claims, and is intended to include all modifications within the scope and the meaning equivalent to the claims.

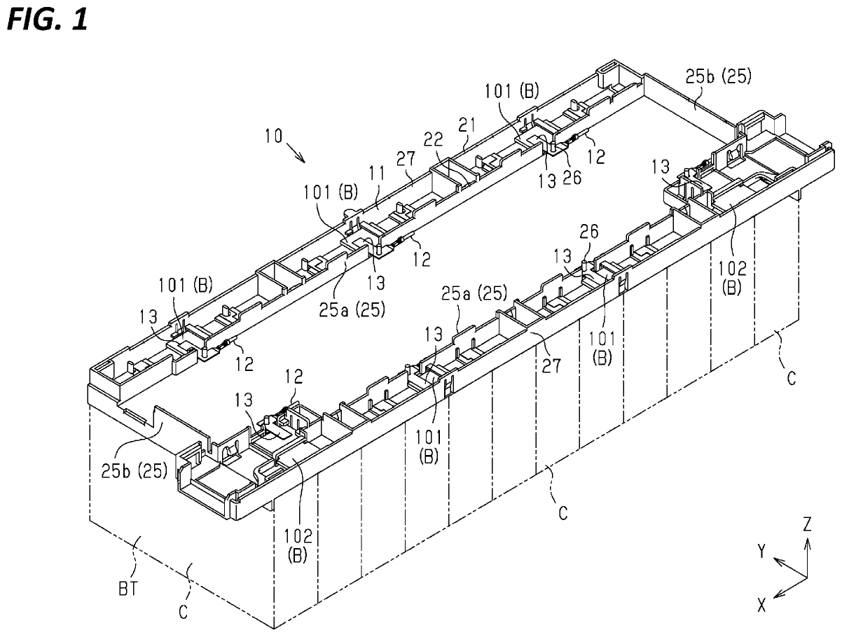

As shown in FIG. 1, a battery wiring module 10 of the present embodiment is attached to a rectangular parallelepiped secondary battery BT. The secondary battery BT is mounted on an electric vehicle, a hybrid vehicle, or the like. The secondary battery BT supplies electric power to a driving motor for a vehicle. Furthermore, the secondary battery BT is supplied with electric power from the driving motor or a power generation motor, depending on charge conditions or vehicle driving conditions.

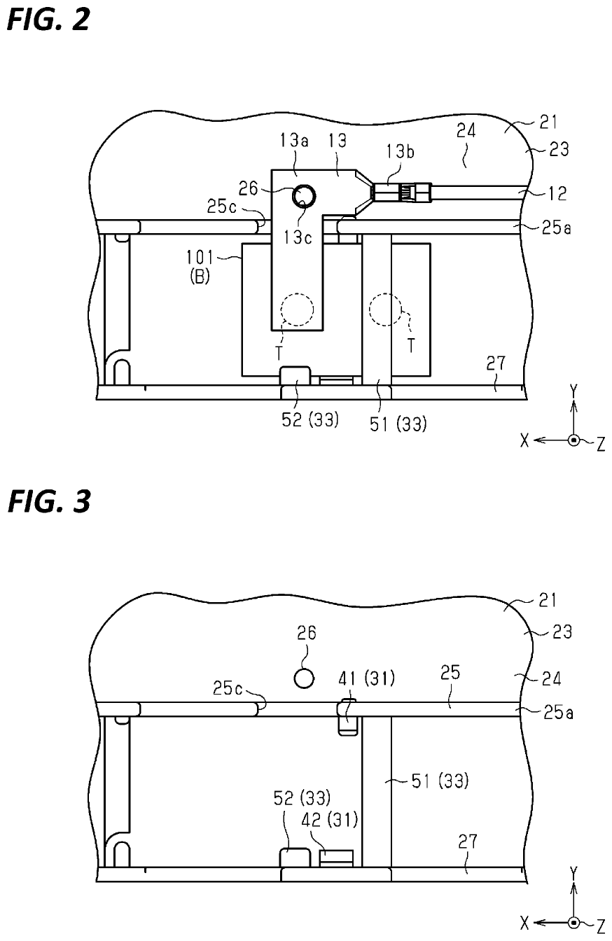

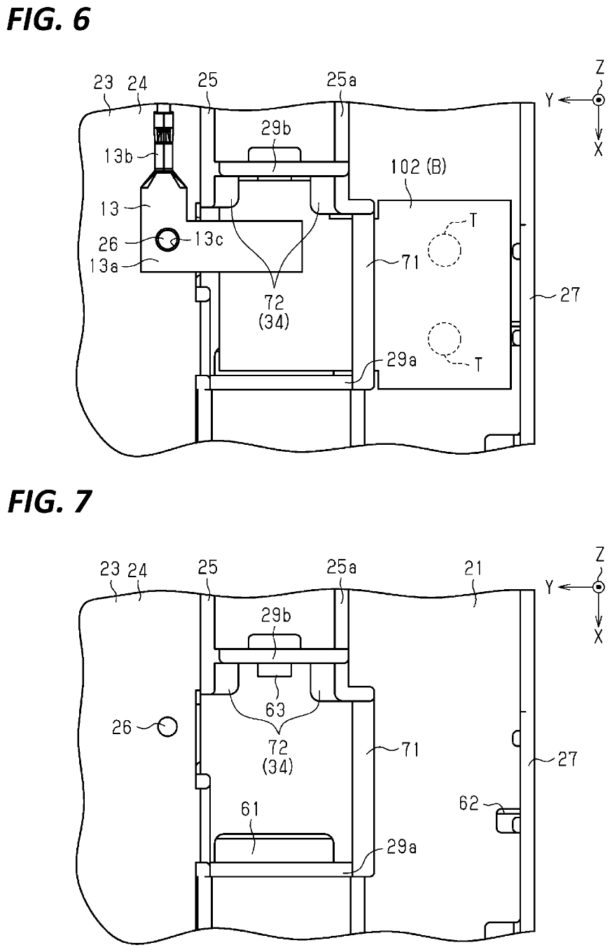

The secondary battery BT includes a plurality of battery cells C, and a battery terminal T (see FIGS. 2 and 6) of each battery cell C faces the battery wiring module 10 side (upper side). The plurality of battery cells C are disposed in one direction. In the following description, among an X direction, a Y direction, and a Z direction which are three directions orthogonal to each other in FIG. 1, the direction in which the battery cells C are disposed is defined as the X direction, the vertical direction which is the mounting direction (stacking direction) of the battery wiring module 10 and the secondary battery BT among the directions orthogonal to the X direction is defined as the Z direction, and the direction orthogonal to the X direction and the Z direction is defined as the Y direction. Also, a side on which the battery wiring module 10 is mounted with respect to the secondary battery BT is referred to as an upper side. That is to say, the battery wiring module 10 is mounted on the secondary battery BT.

Each battery cell C has, for example, a rectangular parallelepiped shape, and is provided with, for example, two battery terminals T on the upper surface on a battery wiring module 10 side. One of the two battery terminals T provided in each battery cell C is a positive electrode terminal, and the other is a negative electrode terminal. The positive electrode terminal and the negative electrode terminal are disposed apart from each other in the Y direction on the upper surface of the battery cell C. At this time, the battery cells C are disposed in such a manner that the directions of the battery cells C are alternately reversed so that the positive electrode terminals and the negative electrode terminals are alternately disposed in the disposition direction, that is to say, in the X direction. With this configuration, two rows in which the positive electrode terminals and the negative electrode terminals are alternately disposed in the X direction are formed.

Each pair of battery terminals is provided with a bus bar B for connecting adjacent terminals, that is to say, the positive electrode terminal and the negative electrode terminal. The bus bar B connects the battery terminals adjacent to each other in the X direction, that is to say, the positive electrode terminal and the negative electrode terminal adjacent to each other in the X direction. With this configuration, the battery cells C are connected in series by the bus bars B. The bus bar B of this example is connected to, for example, the positive electrode terminal and the negative electrode terminal of each battery cell C by welding. The bus bar B of the present embodiment includes two types of bus bars 101 and 102. The two types of bus bars 101 and 102 are different in size and shape, and, for example, the bus bars 102 are provided at both ends in the X direction, and the bus bars 101 are provided at other positions.

(Configuration of Battery Wiring Module 10)

As shown in FIG. 1, the battery wiring module 10 of the present embodiment includes a housing 11, a plurality of electric wires 12, and a plurality of module-side terminals 13.

(Configuration of Electric Wire 12)

Each electric wire 12 includes a core wire made of a conductive member and a covering portion covering the core wire and made of an insulating member.

(Configuration of Module-Side Terminal 13)

Each module-side terminal 13 of the present embodiment is made of a conductive metal plate material.

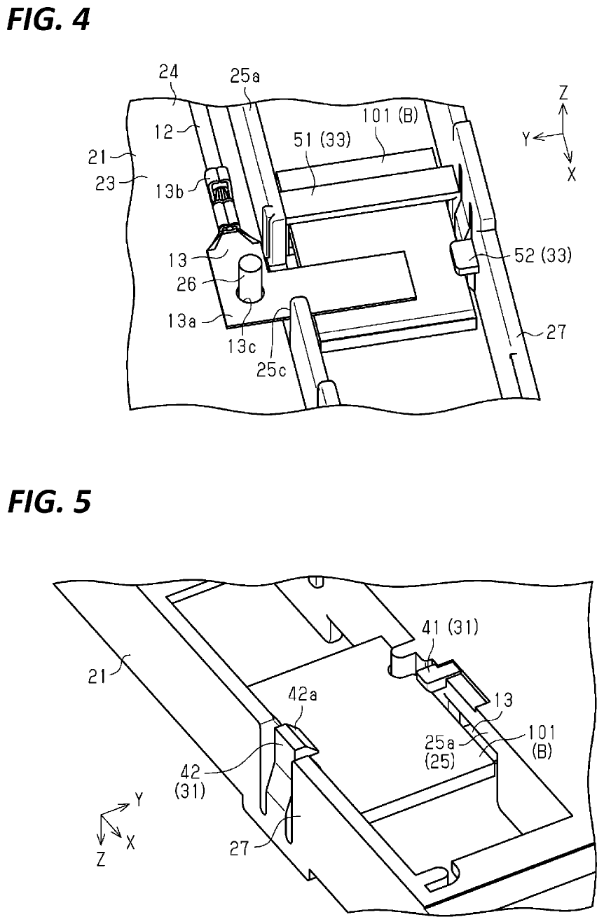

As shown in FIGS. 2 and 4, each module-side terminal 13 includes a plate-shaped terminal body portion 13a, and a barrel portion 13b extending from the terminal body portion 13a and connected to end portion of the electric wire 12.

(Configuration of Housing 11)

As shown in FIG. 1, the housing 11 includes a housing body 21 and a cover (not shown) to be attached to the housing body 21.

The housing body 21 has a shape such that, for example, the size in the X direction, which is the direction in which the battery cells C are disposed, is longer than the size in the Y direction, which is the width direction. The housing body 21 has a shape whose upper shape is open. The housing body 21 is made of, for example, an insulating resin member.

As shown in FIGS. 2, 3, 6, and 7, the housing body 21 includes accommodating portions 23 respectively accommodating the electric wires 12 and the module-side terminals 13.

Each accommodating portion 23 has a bottom surface portion 24 and a peripheral wall portion 25 extending in a direction orthogonal to the bottom surface portion 24. In addition, the accommodating portion 23 includes a positioning pin 26 on the bottom surface portion 24. The positioning pin 26 is inserted into a through hole 13c formed in the module-side terminal 13, so that the position of the module-side terminal 13 in the accommodating portion 23 is set. In addition, the module-side terminal 13 is prevented from being displaced in a direction intersecting the direction in which the positioning pin 26 extends, by the positioning pin 26 being inserted into the through hole 13c.

The accommodating portion 23 includes an opening that is open upward in the Z direction, which is opposite to the bottom surface portion 24, and the opening can be closed by the cover (not shown). The peripheral wall portion 25 includes a pair of first side wall portions 25a extending in the X direction, and a pair of second side wall portions 25b extending in the Y direction. The pair of first side wall portions 25a face each other in the Y direction. The pair of second side wall portions 25b face each other in the X direction. In each first side wall portion 25a, a plurality of opening portion 25c opening in the Y direction are formed in the X direction.

A part of the module-side terminal 13 is drawn out from the opening portion 25c to face outward in the Y direction. The portion drawn out from the opening portion 25c is electrically connected to the bus bar 101 or 102.

In the housing body 21 of the present embodiment, outer wall portions 27 respectively facing the pair of first side wall portions 25a in the Y direction are provided on the outer side of the first side wall portions 25a in the Y direction. The outer wall portions 27 are provided at positions separated from the first side wall portions 25a in the Y direction. A space in which the bus bar 101 or 102 can be interposed is provided between the outer wall portion 27 and the first side wall portion 25a.

The housing body 21 includes bus bar holding portions 31 and 32 for holding bus bars 101 and 102 respectively, and interference reduction portions 33 and 34 for regulating the movement of the bus bars 101 and 102, respectively.

(Configuration of Bus Bar Holding Portion 31)

As shown in FIG. 5, the bus bar holding portion 31 holds (supports) the bus bar 101 from below in the Z direction, and prevents the bus bar 101 from falling downward. Specifically, the bus bar holding portion 31 includes one fixing support piece 41 and one elastic support piece 42 located below the bus bar 101.

As shown in FIGS. 3 and 5, the fixing support piece 41 is formed to extend outward in the Y direction from the first side wall portion 25a of the peripheral wall portion 25.

The elastic support piece 42 is elastically deformable in the Y direction, and includes a claw portion 42a extending inward in the Y direction from the outer wall portion 27 facing the first side wall portion 25a in the Y direction. The elastic support piece 42 is disposed to face the fixing support piece 41 in the Y direction, for example. Because the distance in the Y direction between the elastic support piece 42 (claw portion 42a) and the fixing support piece 41 is narrower (shorter) than the length of the bus bar 101 in the Y direction, the bus bar 101 can be held from below.

In the bus bar holding portion 31 configured as described above, the elastic support piece 42 having the claw portion 42a is bent (elastically deformed) outward in the Y direction when the bus bar 101 is attached from below, so that the bus bar 101 can be easily attached. In the elastic support piece 42, after the bus bar 101 is attached, the elastic support piece 42 returns to its original position, so that the bus bar 101 can be held from below by the elastic support piece 42 and the fixing support piece 41.

(Configuration of Interference Reduction Portion 33)

As shown in FIGS. 2 to 4, a plurality of interference reduction portions 33 are provided for one bus bar 101. More specifically, the interference reduction portion 33 includes an interference reduction rib 51 serving as a first interference reduction portion, and an interference reduction rib 52 serving as a second interference reduction portion. The interference reduction rib 51 is provided to straddle the first side wall portion 25a and the outer wall portion 27, and is provided to cross the bus bar 101 in the Y direction. The interference reduction rib 51 is integrally formed with the first side wall portion 25a and the outer wall portion 27. The interference reduction rib 51 has a plate shape.

The interference reduction rib 52 is provided to extend from the outer wall portion 27 toward the first side wall portion 25a side, which is the inner side in the Y direction. The interference reduction rib 52 is provided at a position facing the module-side terminal 13 in the Y direction. That is to say, the interference reduction rib 52 is provided to extend toward the module-side terminal 13 drawn out from the opening portion 25c. The interference reduction rib 52 is preferably provided to straddle the outer wall portion 27 and the first side wall portion 25a in the same manner as the interference reduction rib 51, but the position in which the interference reduction rib 52 is formed faces the module-side terminal 13 and the opening portion 25c in the Y direction, and the first side wall portion 25a is not provided at the position in which the interference suppression rib 52 is to be formed. For this reason, the protrusion length of the interference reduction rib 52 from the outer wall portion 27 is set to a length that does not interfere with the module-side terminal 13. That is to say, the interference reduction rib 52 serving as the second interference reduction portion is provided at a position where a space can be provided at the time when the module-side terminal 13 is assembled.

(Configuration of Bus Bar Holding Portion 32)

As shown in FIG. 9, the bus bar holding portions 32 respectively hold (support) the bus bars 102 provided at both end portions in the X direction from below in the Z direction, and prevent the bus bars 102 from falling downward. Specifically, each bus bar holding portion 32 includes two fixing support pieces 61 and 62, and one elastic support piece 63 located below the bus bar 102.

As shown in FIGS. 7 and 9, the fixing support piece 61 is formed to extend inward in the X direction from an opposing wall portion 29a located outward in the X direction of two opposing wall portions 29a and 29b. The fixing support piece 62 is formed to extend inward in the Y direction from the outer wall portion 27 located outward in the Y direction.

The elastic support piece 63 is provided on the opposing wall portion 29b located on the inner side in the X direction of the two opposing wall portions 29a and 29b. The elastic support piece 63 is elastically deformable in the X direction, and includes a claw portion 63a extending outward in the X direction from the opposing wall portion 29b.

The elastic support piece 63 is disposed to face the fixing support piece 61 in the X direction, for example. Because the distance in the X direction between the claw portion 63a of the elastic support piece 63 and the fixing support piece 61 is narrower (shorter) than the length of the bus bar 102 in the X direction, the bus bar 102 can be held from below.

In the bus bar holding portion 32 configured as described above, the elastic support piece 63 having the claw portion 63a is bent (elastically deformed) outward in the Y direction when the bus bar 102 is attached from below, so that the bus bar 102 can be easily attached. After the bus bar 102 is attached, the elastic support piece 63 of the bus bar holding portion 32 returns to its original position, so that the bus bar 102 can be held from below by the elastic support piece 63 and the two fixing support pieces 61 and 62.

(Configuration of Interference Reduction Portion 34)

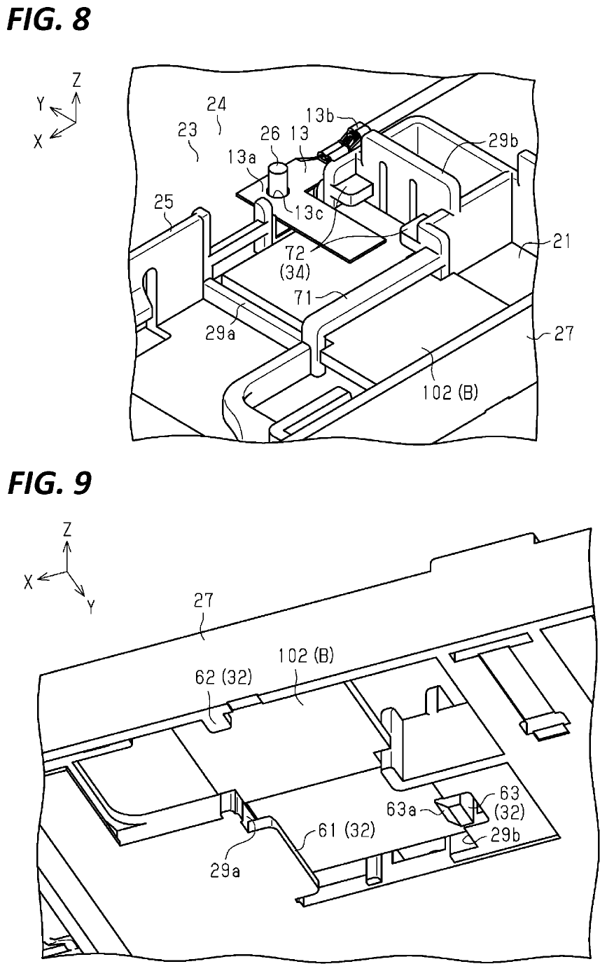

As shown in FIGS. 6, 7, and 8, a plurality of interference reduction portions 34 are provided for one bus bar 102. More specifically, the interference reduction portion 34 includes an interference reduction rib 71 serving as a first interference reduction portion, and interference reduction ribs 72 serving as second interference reduction portions. The interference reduction rib 71 is provided to straddle the pair of opposing wall portions 29a and 29b, and is provided to cross the bus bar 102 in the X direction. The interference reduction rib 71 is integrally formed with the two opposing wall portions 29a and 29b. The interference reduction rib 71 has a plate shape.

Two interference reduction ribs 72 are provided on the opposing wall portion 29b on the inner side in the X direction of the two opposing wall portions 29a and 29b. At least one of the two interference reduction ribs 72 is provided at a position facing the module-side terminal 13, when viewed from the connection direction (Z direction) of the bus bar 102 and the module-side terminal 13. The protrusion length of the interference reduction rib 72 from the opposing wall portion 29b is set not to interfere with the module-side terminal 13.

The operation of the present embodiment will be described next.

The battery wiring module 10 of the present embodiment is disposed on the secondary battery BT including the plurality of battery cells C. The module-side terminals 13 of the battery wiring module 10 are connected to the bus bars B connecting the battery terminals T of the adjacent battery cells C disposed in the X direction. The end on one side of each of the electric wires 12 is connected to the module-side terminal 13, and the end on the other side of each of the electric wires 12 is connected to a battery monitoring ECU (not shown). The battery monitoring ECU can monitor the voltage of the corresponding battery cell C.

In the battery wiring module 10 of the present embodiment, the bus bars 101 and 102 can be attached from below in the Z direction of the housing body 21, in a state where the module-side terminals 13 and the electric wires 12 are attached to the housing body 21. The bus bars 101 and 102 are held by the bus bar holding portions 31 and 32 provided in the housing body 21, respectively, and are prevented from falling downward.

The positioning pin 26 of the housing body 21 is inserted into a through hole 13c of the module-side terminal 13. Accordingly, when an operation of pushing up the module-side terminal 13 from below by the bus bars 101 and 102 is performed, a load is applied to the module-side terminal 13 between the module-side terminal 13 and the positioning pin 26 and between the module-side terminal 13 and the peripheral wall portion 25. For this reason, in the present embodiment, in order to prevent the module-side terminal 13 from being pushed up from below by the bus bars 101 and 102, the interference reduction portions 33 and 34 for restricting movement of the bus bars 101 and 102 in the connection direction (Z direction) are provided.

The effects of the present embodiment will be described next.

1. Because the movement of the bus bars 101 and 102 in the Z direction, which is the connection direction between the bus bars 101 and 102 and the module-side terminals 13, is restricted by the interference reduction portions 33 and 34, respectively, strong interference of the bus bars 101 and 102 with the module-side terminals 13 can be reduced.

2. By providing the plurality of interference reduction ribs 51 and 52 for each of the bus bars 101, and the plurality of interference reduction ribs 71 and 72 for each of the bus bars 102, it is possible to more reliably reduce interference of the bus bars 101 and 102 with the module-side terminals 13.

3. By providing the plurality of types of interference reduction ribs 51 and 52 for each of the bus bars 101 and the plurality of types of interference reduction ribs 71 and 72 for each of the bus bars 102, it is possible to more reliably reduce interference of the bus bars 101 and 102 with the module-side terminals 13.

4. Movement of the bus bars 101 and 102 is regulated, by the interference reduction ribs 51 provided to straddle the first side wall portions 25a and the outer wall portions 27, and the interference reduction ribs 71 provided to straddle the pairs of the opposing wall portions 29a and 29b. In each bus bar 101, the rotation of the bus bar 101 can be regulated by the interference reduction rib 52 provided for regulating the movement of the bus bar 101 at a position apart from the interference reduction rib 51, and, in each bus bar 102, the rotation of the bus bar 102 can be regulated by the interference reduction rib 72 provided for regulating the movement of the bus bar 102 at a position apart from the interference reduction rib 71.

5. The interference reduction rib 52 serving as the second interference reduction portion is provided to extend from the outer wall portion 27 of the first side wall portion 25a and the outer wall portion 27 constituting the pair of wall portions toward the module-side terminal 13. Similarly, the interference reduction rib 72 serving as the second interference reduction portion is provided to extend from the opposing wall portion 29b of the opposing wall portions 29a and 29b constituting the pair of wall portions toward the module-side terminal 13. With this configuration, the module-side terminal 13 can be disposed in the vicinity of the interference reduction ribs 52 and 72. As a result, interference of the bus bar with the module-side terminal 13 can be more reliably reduced. In addition, because the interference reduction ribs 52 and 72 are provided at positions that do not overlap the module-side terminals 13 in the Z direction, when the module-side terminals 13 are assembled, interference of the module-side terminals 13 with the interference reduction ribs 52 and 72 is reduced, and a space for assembling the module-side terminals 13 can be provided.

6. The bus bars 101 and 102 can be held by the bus bar holding portions 31 and 32, respectively.

7. The bus bar holding portion 31 or 32 is positioned on one side of the module-side terminal 13 and the interference reduction portion 33 or 34 is provided on the other side of the module-side terminal 13. With this configuration, when the bus bars 101 and 102 held by the bus bar holding portions 31 and 32 are attached, even if the module-side terminals 13 are pushed by the bus bars 101 and 102, the movement of the bus bars 101 and 102 is regulated by the interference reduction portions 33 or 34 positioned on the other side of the module-side terminal 13. As a result, interference of the bus bar with the module-side terminal 13 can be more reliably suppressed/reduced.

8. The bus bars 101 and 102 can be easily attached by the elastic support pieces 42 and 63 elastically deforming when attaching the bus bars 101 and 102, and the bus bars 101 and 102 can be held by the elastic support pieces 42 and 63 and the fixing support pieces 41, 61, and 62 by the elastic support pieces 42 and 63 returning to their original positions after attaching the bus bars 101 and 102.

### OTHER EMBODIMENTS

The above embodiment can be implemented with the following modifications. The above embodiment and the following modifications can be implemented in combination with one another as long as there is no technical contradiction.

In the above embodiment, the plurality and plural types of interference reduction ribs 51 and 52 are provided for each of the bus bars 101, and the plurality and plural types of interference reduction ribs 71 and 72 are provided for each of the bus bars 102, but the present disclosure is not limited to this configuration. A plurality of interference reduction portions (interference reduction ribs) having the same shape, that is to say, of the same type may also be provided for each bus bar, for example. Alternatively, one interference reduction portion may also be provided for each bus bar. Also, a plurality and plural types of interference reduction portions may be provided for one of the plurality of bus bars as in the above embodiment, and one interference reduction portion may be provided for the other bus bars, or a plurality of interference reduction portions of the same type may be provided for the other bus bars.

In the above embodiment, the interference reduction rib 52 is provided to extend from the outer wall portion 27 toward the module-side terminal 13, and the interference reduction rib 72 is provided to extend from the opposing wall portion 29b toward the module-side terminal 13, but the present disclosure is not limited to this configuration. In other words, the interference reduction ribs 52 and 72 do not need to extend toward the module-side terminal 13. The interference reduction rib 52 may also be provided to straddle the first side wall portion 25a and the outer wall portion 27 in the same manner as the interference reduction rib 51 that is paired with the interference reduction rib 52, for example. Similarly, the interference reduction rib 72 may also be provided to straddle the pair of opposing wall portions 29a and 29b in the same manner as the interference reduction rib 71 that is paired with the interference reduction rib 72. In any case, the interference reduction ribs 52 and 72 are preferably provided at positions that do not overlap the module-side terminal 13 in the Z direction. With this configuration, a space for assembling the module-side terminal 13 can be obtained.

In the above embodiment, the interference reduction rib 51 is provided to straddle the first side wall portion 25a and the outer wall portion 27, and the interference reduction rib 71 is provided to straddle the pair of opposing wall portions 29a and 29b, but the present disclosure is not limited to this configuration. When a configuration in which the interference reduction rib 51 crosses the bus bar 101 when viewed from the Z direction, for example, is employed, the interference reduction rib 51 may not straddle the wall portions 25a and 27, and when a configuration in which the interference suppression rib 71 crosses the bus bar 102 when viewed from the Z direction, for example, is employed, the interference suppression rib 71 may not straddle the wall portions 29a and 29b. In other words, the interference reduction rib 51 may also be formed to extend from one of the first side wall portion 25a and the outer wall portion 27, and may not be connected to the other of the first side wall portion 25a and the outer wall portion 27, in a state where the interference reduction rib 51 crosses the bus bar 101 when viewed from the Z direction. Similarly, the interference reduction rib 71 may also be formed to extend from one of the pair of opposing wall portions 29a and 29b, and may not be connected to the other of pair of the opposing wall portions 29a and 29b, in a state where the interference reduction rib 71 crosses the bus bar 102 when viewed from the Z direction.

In the above embodiment, the bus bar holding portion 31 is constituted by one elastic support piece 42 and one fixing support piece 41, but the present disclosure is not limited to this configuration. The bus bar holding portion 31 may also be constituted by two elastic support pieces that form a pair, for example.

In addition, the bus bar holding portion 32 is constituted by the elastic support piece 63 and the two fixing support pieces 61 and 62, but the present disclosure is not limited to this configuration. The bus bar holding portion 32 may also be constituted by two elastic support pieces and one fixing support piece, or may also be constituted by three elastic support pieces, for example.

In the above embodiment, the configuration in which the bus bar holding portions 31 and 32 are included is employed, but a configuration in which the bus bar holding portions 31 and 32 are omitted may also be employed.

In the above embodiment, the configuration in which the battery cells C are connected in series by the bus bars is employed, but the present disclosure is not limited to this configuration, and a configuration in which the battery cells C are connected in parallel may also be employed.

The number of battery cells C disclosed in the above embodiment is merely an example, and may also be changed as appropriate. In addition, the number of module-side terminals and electric wires may also be changed as appropriate depending on the number of the battery cells.

In the above embodiment, the battery wiring module is attached to the secondary battery BT mounted on a vehicle, but the battery wiring module may also be attached to a battery mounted on a device other than a vehicle.

Bus bars B (the bus bars 101 and 102) may also have a flat plate-like shape. In other words, the bus bars B (the bus bars 101 and 102) may also have an upper surface and a lower surface.

An opening passing through/penetrating in the Z direction (vertical direction) may be formed in the housing 11.

The interference reduction rib 51 may also be bridged from the pair of wall portions 25a and 27 forming the opening of the housing 11 to extend over the opening.

The interference reduction rib 52 may also protrude from the pair of wall portions 25a and 27 forming the opening of the housing 11 toward the inside of the opening.

The interference reduction rib 71 may also be bridged from the pair of wall portions 29a and 29b forming the opening of the housing 11 to extend over the opening.

The interference reduction rib 72 may also protrude from the pair of wall portions 29a and 29b forming the opening of the housing 11 toward the inside of the opening.

The fixing support piece 41 and the elastic support piece 42 may also protrude from the pair of wall portions 25a and 27 forming the opening of the housing 11 toward the inside of the opening.

The fixing support pieces 61 and 62 and the elastic support piece 63 may also protrude from the pair of wall portions 29a and 29b forming the opening of the housing 11 toward the inside of the opening.

The bus bar holding portion 31 may also be in contact with the lower surface of the bus bar B (the bus bar 101). With this configuration, the bus bar holding portion 31 may also support the lower surface of the bus bar B (the bus bar 101) at two locations (the fixing support piece 41 and the elastic support piece 42) from below the opening of the housing 11. As a result, the bus bar B (the bus bar 101) can be prevented from falling downward.

The bus bar holding portion 32 may also be in contact with the lower surface of the bus bar B (the bus bar 102). With this configuration, the bus bar holding portion 32 may also support the lower surface of the bus bar B (the bus bar 102) at three locations (the fixing support pieces 61 and 62 and the elastic support piece 63) from below the opening of the housing 11. As a result, the bus bar B (the bus bar 102) can be prevented from falling downward.

The interference reduction portion 33 may also be in direct contact with the upper surface of the bus bar B (the bus bar 101) or may also face the upper surface with a gap therebetween. With this configuration, the interference reduction portion 33 may also reduce the movement of the bus bar B (the bus bar 101) at two locations (the interference reduction rib 51 and the interference reduction rib 52) from above the opening of the housing 11. As a result, the bus bar B (the bus bar 101) supported from its lower surface by the bus bar holding portion 31 is in contact with the interference reduction portion 33 at its upper surface, and thus it is possible to reduce further movement of the bus bar B (the bus bar 101).

The interference reduction portion 34 may also be in direct contact with the upper surface of the bus bar B (the bus bar 102) or may also face the upper surface with a gap therebetween. With this configuration, the interference reduction portion 34 may also reduce the movement of the bus bar B (the bus bar 102) at three locations (the interference reduction rib 71 and the pair of interference reduction ribs 72) from above the opening of the housing 11. As a result, the bus bar B (the bus bar 102) supported from its lower surface by the bus bar holding portion 32 is in contact with the interference reduction portion 34 at its upper surface, and thus it is possible to reduce further movement of the bus bar B (the bus bar 102).

The interference reduction portion 33 and the housing body 21 may also be formed integrally. In other words, the interference reduction rib 51 and the housing body 21 may also be integrally formed. Similarly, the interference reduction rib 52 and the housing body 21 may also be integrally formed.

The interference reduction portion 34 and the housing body 21 may also be formed integrally. In other words, the interference reduction rib 71 and the housing body 21 may also be integrally formed. Similarly, the interference reduction rib 72 and the housing body 21 may also be integrally formed.

The bus bar holding portion 31 and the housing body 21 may also be integrally formed. In other words, the fixing support piece 41 and the housing body 21 may also be integrally formed. Similarly, the elastic support piece 42 and the housing body 21 may also be integrally formed.

The bus bar holding portion 32 and the housing body 21 may also be integrally formed. In other words, the fixing support pieces 61 and 62, and the housing body 21 may also be integrally formed. Similarly, the elastic support piece 63 and the housing body 21 may also be integrally formed.

### LIST OF REFERENCE NUMERALS

10 Battery wiring module
11 Housing
12 Electric wire
13 Module-side terminal
13a Terminal body portion
13b Barrel portion
21 Housing body
23 Accommodating portion
24 Bottom surface portion
25 Peripheral wall portion
25a First side wall portion constituting a pair of wall portions
25b Second side wall portion
25c Opening
26 Positioning pin
27 Outer wall portion constituting a pair of wall portions
29a, 29b Opposing wall portion serving as a pair of wall portions 31, 32 Bus bar holding portion
33, 34 Interference reduction portion
41 Fixing support piece
42 Elastic support piece
42a Claw portion
51 Interference reduction rib serving as first interference reduction portion
52 Interference reduction rib serving as second interference reduction portion
61 Fixing support piece
62 Fixing support piece
63 Elastic support piece
63a Claw portion
71 Interference reduction rib serving as first interference reduction portion
72 Interference reduction rib serving as second interference reduction portion
101, 102, B Bus bar
BT Secondary battery
C Battery cell
T Battery terminal

1. A battery wiring module comprising:
module-side terminals electrically connected to bus bars that connect battery terminals of a plurality of battery cells to each other;
electric wires connected to the module-side terminals; and
a housing that houses the electric wires and the module-side terminals,
wherein the housing includes interference reduction portions interposed between the bus bars and the module-side terminals.

2. The battery wiring module according to claim 1,
wherein a plurality of the interference reduction portions are provided for each bus bar.

3. The battery wiring module according to claim 1,
wherein a plurality types of the interference reduction portions are provided for each bus bar.

4. The battery wiring module according to claim 1,
wherein the housing includes a pair of wall portions provided apart from each other at a position where the bus bars are interposable, and
the interference reduction portions each include a first interference reduction portion provided to straddle the pair of wall portions, and a second interference reduction portion interposed between the bus bar corresponding to the first interference reduction portion and the corresponding module-side terminal at a position apart from the first interference reduction portion.

5. The battery wiring module according to claim 4,
wherein the second interference reduction portions are provided to extend from one of the pair of wall portions toward the module-side terminals.

6. The battery wiring module according to claim 1,
wherein the housing includes bus bar holding portions that hold the bus bars.

7. The battery wiring module according to claim 6,
wherein the bus bar holding portions are located on an opposite side to the interference reduction portions in a connection direction of the module-side terminals and the bus bars with respect to the module-side terminals.

8. The battery wiring module according to claim 6,
wherein the bus bar holding portions each include only one set of an elastically deformable elastic support piece and a fixing support piece that is paired with the elastic support piece.
